(19) United States
(12) Patent Application Publication
(10) Pub. No.: US 2007/0131065 A1
(43) Pub. Date: Jun. 14, 2007

(54) Socket size identification

(76) Inventor: Tsai-Chien Shih, Taichung County (TW)

Correspondence Address: CHARLES E. BAXLEY, ESQ., 90 JOHN STREET, THIRD FLOOR, NEW YORK, NY, 10038, US

(21) Appl. No.: 11/297,620

(22) Filed: Dec. 8, 2005

(51) Int. Cl. B25B 13/06; B25B 13/02

(52) U.S. Cl. 81/121.1; 81/119

(57) ABSTRACT

An identification device is disclosed for a socket defining a bit-receiving recess and a handle-receiving recess. The identification device includes a numeric zone and a color zone. The numeric zone is used for identifying the size of the bit-receiving recess. The numeric zone includes a number corresponding to the size of the socket and a background with sharp contrast to the number. The color zone is used for identifying the size of the handle-receiving recess.

### BACKGROUND OF INVENTION

1. Field of Invention

The present invention relates to a system for identifying the size of the handle-receiving recess and the size of the bit-receiving recess by means of laser or printing techniques so that a user can identify the size of a corresponding handle and the size of a corresponding bit with easiness, at a low cost, for a long time.

2. Related Prior Art

Ordinary wrenches for tightening and loosening bolts and nuts are open-ended wrenches, box-ended wrenches and socket wrenches for example. For different sizes of the bolts and nuts, there are different sizes of the wrenches. For instance, a socket wrench set includes a handle and sockets with various sizes. Adjacent two of the sizes are close to each other. Furthermore, the sizes are given in two systems, the metric system and the UK system. Hence, there is a need for a design for quick and precise identification of the sockets. To this end, there are some designs such as those disclosed in Taiwanese Patent Publication Nos. 555626, 566272 and 530724 and U.S. Pat. No. 6,393,950.

However, there are problems with the above-mentioned designs. A number is formed on or cut in a socket by means of molding or pressing for example. As the color of the number is identical to that of the rest of the socket, there is not without difficulty in recognizing the number. Where the number is cut in the socket, the number can be filled with filth so that it cannot be recognized. Moreover, it takes electrical plating, polishing and dying in order to cut the number in the socket. The cost is inevitably high. There are designs based on colors. However, without numbers, it still takes a user a lot of time to memorize the relationship between the sizes and the colors before using them, and it takes the user some time to recall the relationship every time he or she uses them.

In addition, a socket includes a bit-receiving recess for receiving a tool bit and a handle-receiving recess for receiving a handle. The foregoing conventional designs are provided for the identification of the various sizes of the bit-receiving recesses. Yet, there are at least three different sizes of the handle-receiving recesses. There is no design for the identification of the different sizes of the handle-receiving recesses. The identification of the different sizes of the handle-receiving recesses depends on personal experience and visual observation, and this is inconvenient.

As discussed above, the conventional designs for the identification of the sizes of the sockets are far from perfect. They cannot be recognized easily and quickly. They do not last long. They involve high costs.

The present invention is therefore intended to obviate or at least alleviate the problems encountered in prior art.

### SUMMARY OF INVENTION

It is the primary objective of the present invention to provide a design for identifying the size of the bit-receiving recess and the size of the handle-receiving recess so that a user can inspect quickly and that the design can be provided at a low cost.

According to the present invention, an identification device is disclosed for a socket defining a bit-receiving recess and a handle-receiving recess. The identification device includes a numeric zone and a color zone. The numeric zone is used for identifying the size of the bit-receiving recess. The numeric zone includes a number corresponding to the size of the socket and a background with sharp contrast to the number. The color zone is used for identifying the size of the handle-receiving recess.

Other objectives, advantages and features of the present invention will become apparent from the following detailed description referring to the attached drawings.

### BRIEF DESCRIPTION OF DRAWINGS

The present invention will be described through the description of some embodiments referring to the drawings.

FIG. 1A is a perspective view of a socket according to the present invention, and shows a carved number of a numeric identification zone.

FIG. 1B is a perspective view of a socket according to the present invention, and shows a carved background of a numeric identification zone.

FIG. 2 is a perspective view of the socket shown in FIG. 1A in use for quick identifying a related selective one-way wrench and a related screwdriver bit.

FIG. 3 is a perspective view of a bi-axial wrench used with the socket shown in FIG. 1A.

FIG. 4 is a perspective view of a screwdriver used with the socket shown in FIG. 1A.

FIG. 5 is a perspective view of an extension shaft used with the socket shown in FIG. 1A.

FIG. 6 is a perspective view of a flexible extension shaft used with the socket shown in FIG. 1A.

FIG. 7 is a perspective view of a universal joint used with the socket shown in FIG. 1A.

FIG. 8 is a perspective view of a T-shaped wrench used with the socket shown in FIG. 1A.

### DETAILED DESCRIPTION OF EMBODIMENTS

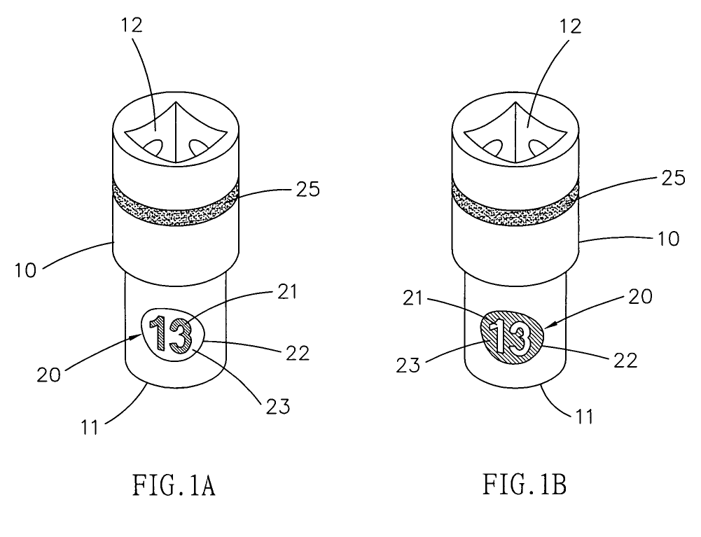

Referring to FIG. 1A, there is a socket 10 with an identification device according to a first embodiment of the present invention. The socket 10 includes a bit-receiving recess 11 made in an end and a handle-receiving recess 12 made in an opposite end.

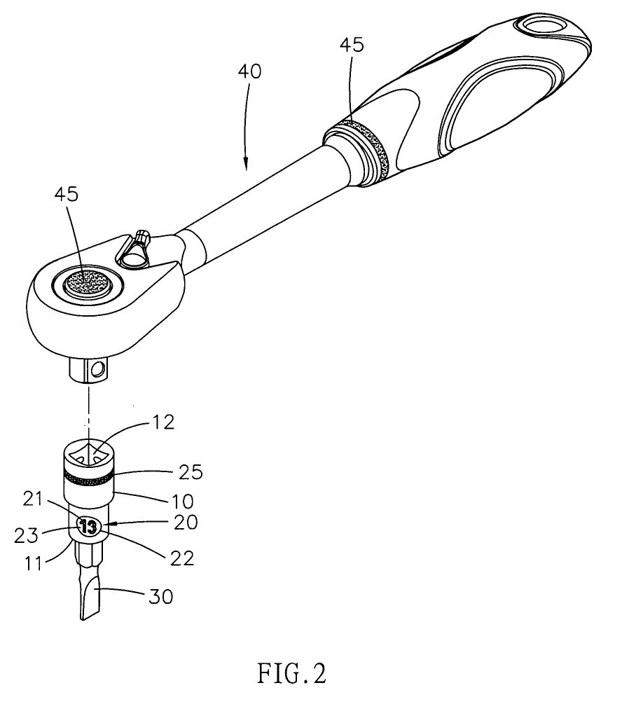

The bit-receiving recess 11 can receive a bit such as a bit 30 of a screwdriver shown in FIG. 2. The term “bit-receiving” is given for the convenience of description, not for the limitation of the scope of this invention. The bit-receiving recess 11 can however receive a fastener such as a nut, a bolt and a screw. The bit-receiving recess 11 is made with one of tens of sizes according to the metric system or the UK system.

The handle-receiving recess 12 can receive a handle such as a handle 40 of a selective one-way wrench shown in FIG. 2. The handle-receiving recess 12 is made with one of about four common sizes.

The identification design includes a numeric zone 20 and a color zone 25. The socket 10 is like any other socket except the identification device and hence the structure thereof will not be described in detail.

The numeric zone 20 is provided for identifying the size of the bit-receiving recess 11 and is therefore positioned in the vicinity of the bit-receiving recess 11. The numeric zone 20 includes a number 21, a frame 22 around the number 21 and a background 23 between the number 21 and the frame 22. The number 21 is given corresponding to one of the sizes according to the metric system or the UK system. The frame 22 may be a circle, a triangle, a rectangle, a polygonal, a star or any other proper pattern. In the first embodiment, the frame 22 is a circle. The background 23 is made with sharp contrast to the number 21 so that the number 21 can easily be observed amid the background 23. The contrast may be color difference made by means of laser, printing or any other proper technique. In the first embodiment, the number 21 is processed by means of laser while the background 23 is left blank.

The color zone 25 is provided for identifying the size of the handle-receiving recess 12 and is hence positioned in the vicinity of the handle-receiving recess 12. The color zone 25 is given corresponding to one of the common sizes of the handle-receiving recess 12. Preferably, the handle 40 of the selective one-way wrench is provided with a color zone 45 corresponding to the color zone 25. Thus, the relation between the socket 10 and the handle 40 of the selective one-way wrench can easily be recognized. The color zone 25 is preferably a color stripe around the socket 10 so that the color zone 25 can be observed from every angle. Similarly, the color zone 45 is a color stripe around the handle 40 of the selective one-way wrench.

The number of the sizes available for the bit-receiving recess 11 is a lot larger than the number of the sizes available for the handle-receiving recess 12. In order to tell precisely the size of the bit-receiving recess 11, the numeric zone 20 is provided. On the contrary, the color zone 25 would provide adequate effects should the handle 40 of the selective one-way wrench not be provided with the color zone 45.

As discussed above, the identification device can easily and quickly be recognized and involves a low cost.

Referring to FIG. 1B, there is shown a socket 10 according to the second embodiment of the present invention. The second embodiment is identical to the first embodiment except that the background 23 is processed by means of laser while the number 21 is left blank.

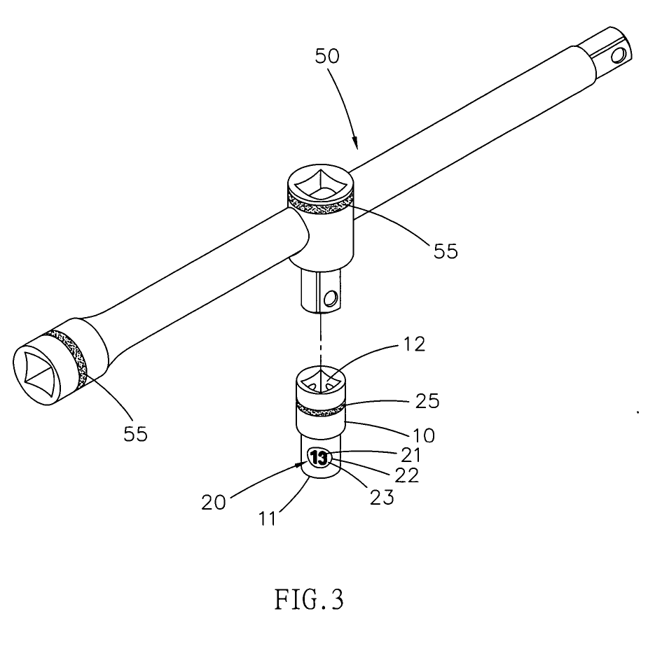

Referring to FIG. 3, the identification device is provided for a bi-axial wrench 50. The bi-axial wrench 50 includes two handles each provided with a color zone 55 corresponding to the color zone 25 provided on the socket 10.

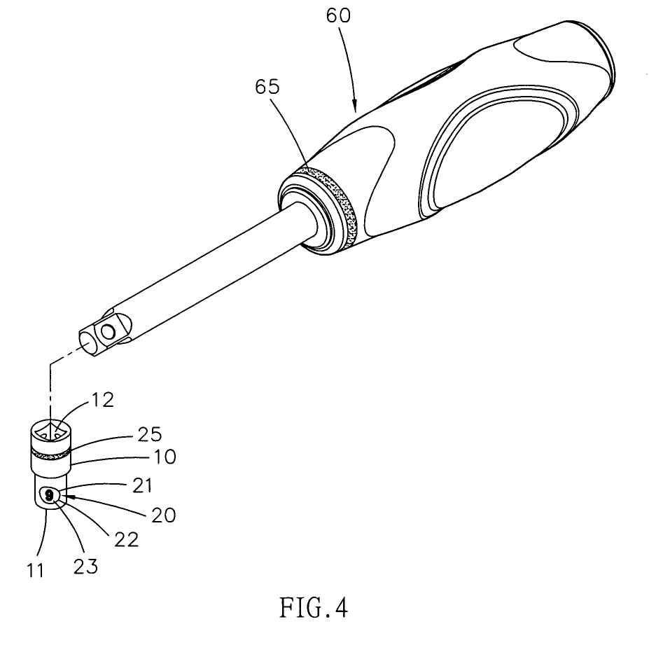

Referring to FIG. 4, the identification device is provided for a screwdriver 60. The screwdriver 60 is provided with a color zone 65 corresponding to the color zone 25 provided on the socket 10.

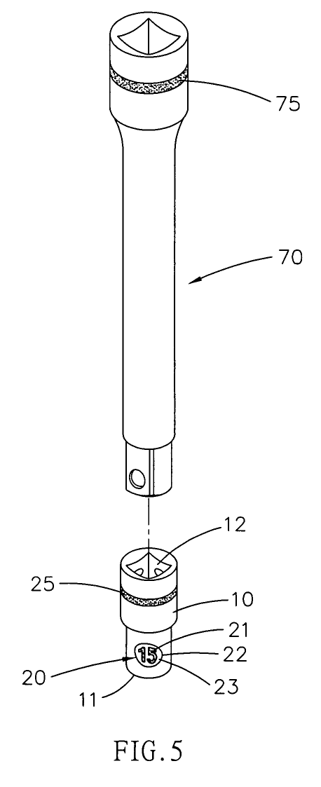

Referring to FIG. 5, the identification device is provided for an extension shaft 70. The extension shaft 70 is given a color zone 75 corresponding to the color zone 25 provided on the socket 10.

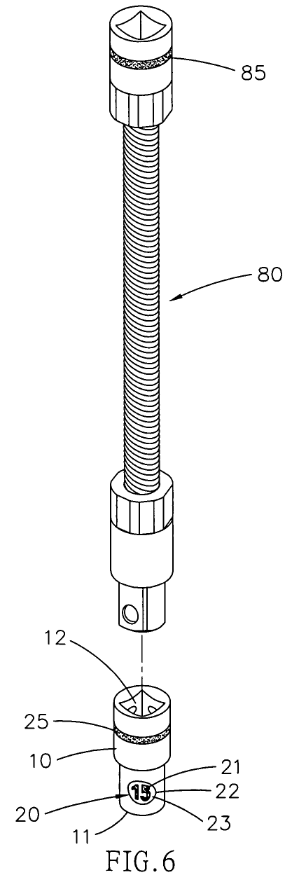

Referring to FIG. 6, the identification device is provided for a flexible extension shaft 80. The flexible extension shaft 80 is given a color zone 85 corresponding to the color zone 25 provided on the socket 10.

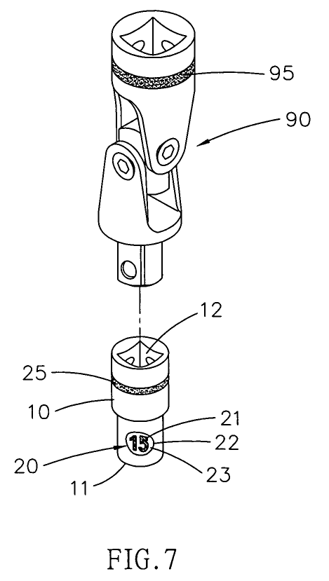

Referring to FIG. 7, the identification device is provided for a universal joint 90. The universal joint 90 is given a color zone 95 corresponding to the color zone 25 provided on the socket 10.

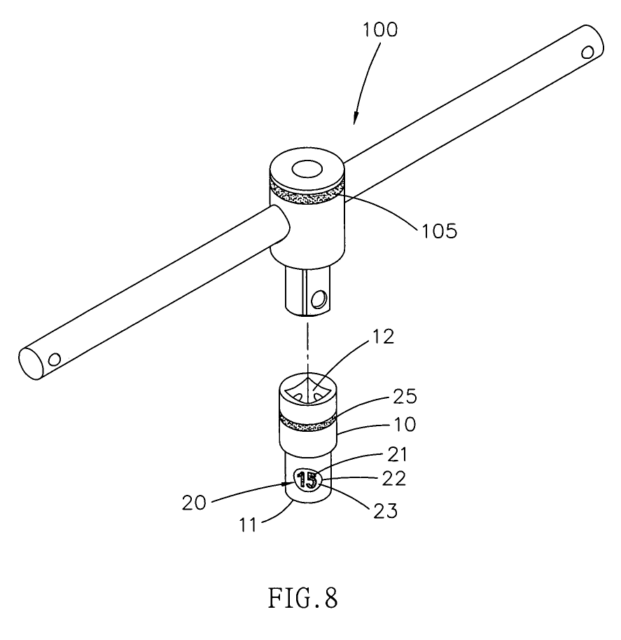

Referring to FIG. 8, the identification device is provided for a T-shaped wrench 100. The T-shaped wrench 100 given a color zone 105 corresponding to the color zone 25 provided on the socket 10.

The present invention has been described through the description of the embodiments. Those skilled in the art can derive variations from the embodiments without departing from the scope of the present invention. Therefore, the embodiments shall not limit the scope of the present invention defined in the claims.

What is claimed is:

1. An identification device for a socket defining a bit-receiving recess and a handle-receiving recess, the identification device comprising:
a numeric zone for identifying the size of the bit-receiving recess, the numeric zone comprising a number corresponding to the size of the socket and a background with sharp contrast to the number; and
a color zone for the identifying the size of the handle-receiving recess.

2. The identification device according to claim 1 wherein the contrast between the number and the background is made by means of laser.

3. The identification device according to claim 1 wherein the contrast is color difference.

4. The identification device according to claim 1 wherein the numeric zone is positioned near the bit-receiving recess.

5. The identification device according to claim 1 wherein the color zone is positioned near the handle-receiving recess.

6. The identification device according to claim 1 wherein the number is processed with the laser while the background is left blank.

7. The identification device according to claim 1 wherein the background is processed with the laser while the number is left blank.

8. The identification device according to claim 1 wherein the numeric zone comprises a frame around the background.

9. The identification device according to claim 8 wherein the frame is selected from proper geographic patterns.

10. The identification device according to claim 1 wherein the identification device is used in a selective one-way wrench.

11. The identification device according to claim 1 wherein the identification device is used in a bi-axial wrench.

12. The identification device according to claim 1 wherein the identification device is used in an extension shaft.

13. The identification device according to claim 1 wherein the identification device is used in a flexible extension shaft.

14. The identification device according to claim 1 wherein the identification device is used in a universal joint.

15. The identification device according to claim 1 wherein the identification device is used in a screwdriver.

16. The identification device according to claim 1 wherein the identification device is used in a T-shaped wrench.
